(19) United States
(12) Patent Application Publication
(10) Pub. No.: US 2010/0085461 A1
(43) Pub. Date: Apr. 8, 2010

(54) Charge coupled device image sensor including first amplifier connected to two registers and second amplifier connected to register

(75) Inventor: Noboru Takatsuka, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/588,073

(22) Filed: Oct. 2, 2009

(30) Foreign Application Priority Data
Oct. 7, 2008 (JP) 2008-260286

(51) Int. Cl. H04N 5/335

(52) U.S. Cl. 348/316; 348/300; 348/E05.091

(57) ABSTRACT

A CCD image sensor includes: first and second CCD registers arranged so as to sandwich a pixel array therebetween, a first output portion provided to a connection part of the first and second CCD registers, a third CCD register which reads out and transfers the charge transferred by one of the first and second CCD registers, a second output portion provided to an end portion of the third CCD register, and a switch for changing whether or not to perform an output by the second output portion, depending on an operation mode.

### INCORPORATION BY REFERENCE

This application is based upon and claims the benefit of priority from Japanese Patent Application No. 2008-260286 which was filed on Oct. 7, 2008, the disclosure of which is incorporated herein in its entirety by reference.

### BACKGROUND OF THE INVENTION

1. Field of the Invention

The present invention relates to an image sensor using a CCD (Charge Coupled Device).

2. Description of Related Art

A CCD is one of many photoelectric conversion devices, and there have been many applications of a CCD to a video camera and the like due to its excellent high-speed and high-sensitivity properties. For an image sensor using such a CCD, power saving and further speeding up are required. However, such a CCD has technically incompatible aspects in achieving power saving and speeding up. If one aspect is specially specifically, then another aspect is sacrificed.

FIG. 4 shows a configuration of a CCD image sensor 101 for achieving power saving, and FIG. 5 shows a timing chart of this CCD image sensor 101 of a first related art. FIG. 4 shows an example in which a pixel array 102 consists of eight pixels for simplicity of description. Charges photoelectrically converted and stored by the pixel array 102 are read out to CCD registers 105, 106, which transfer the charges, by setting transfer gates 103, 104 to “H.” Here, odd-numbered pixels are read out to the first CCD register 105 through the first transfer gate 103, while even-numbered pixels are read out to the second CCD register 106 through the second transfer gate 104. The charges transferred by the CCD registers 105, 106 are outputted to the outside by a signal charge detection unit 107 and an amplifier 108 (see Patent Document 1). The signal charge detection unit 107 is formed of a floating diffusion area and converts each of the charges into a voltage. The amplifier 108 consists of analog circuits such as a source follower and an inverter.

In the aforementioned CCD image sensor 101 shown in FIG. 4, a charge for one pixel is transferred in one cycle of each of the CCD registers 105, 106, and the charges transferred by the. CCD registers 105, 106 are alternately converted into a voltage by the single signal charge detection unit 107. Accordingly, two pixels are outputted by the CCD registers 105, 106 in one cycle, and a time period required to transfer eight pixels is (8/2)/f=4/f where the driving frequency of the CCD registers 105, 106 is f. Incidentally, in FIG. 5, an arrow A indicates a period in which a signal to be outputted from the amplifier 108 is stabilized.

Meanwhile, FIG. 6 shows a configuration of a CCD image sensor 201 for achieving speeding up, and FIG. 7 shows a timing chart of the CCD image sensor 201 of a second related art. Note that parts exhibiting the same or similar operations and effects as the aforementioned CCD image sensor 101 shown in FIG. 4 are denoted by the same reference numerals, and description thereof is omitted. In the CCD image sensor 201, steps till readout of the charges to the first and second CCD registers 105, 106 are the same as those of the aforementioned CCD image sensor 101 shown in FIG. 4. In the CCD image sensor 201 shown in FIG. 6, the CCD registers 105, 106 are provided with signal charge detection units 207, 208, respectively, and amplifiers 209, 210, respectively. This means that a charge transferred by the first CCD register 105 is outputted from the first amplifier 209 through the first signal charge detection unit 207, while a charge transferred by the second CCD register 106 is outputted from the second amplifier 210 through the second signal charge detection unit 208 (see Patent Document 2).

In the aforementioned CCD image sensor 201 shown in FIG. 6, the charge for one pixel is transferred in one cycle of each of the CCD registers 105, 106, and the charges are outputted respectively by the two amplifiers 209, 210 parallelly. This means that a time period required to transfer eight pixels is (8/2)/f=4/f where the driving frequency of the CCD registers 105, 106 is f. In FIG. 7, an arrow B indicates a period in which a signal to be outputted from each of the amplifiers 209, 210 is stabilized.

Furthermore, as another prior art, disclosed is a solid-state image pickup device (CCD image sensor) including: a first horizontal transfer means (CCD register) for transferring, in one direction, a signal charge stored by one of light receiving elements (pixel array); a second horizontal transfer means for transferring, in a right or left direction, the signal charge from a predetermined position; a first output means (amplifier) for converting, into an analog signal, the signal charge transferred by the first horizontal transfer means; a second output means for converting, into an analog signal, the signal charge transferred in the right direction from the second horizontal transfer means; and a third output means for converting, into an analog signal, the signal charge transferred in the left direction from the second horizontal transfer means (see Patent Document 3). It is said that, with this configuration, both speeding up of processing and high quality imaging can be achieved by changing the horizontal transfer means and output means to be used, based on operations, set conditions and environmental conditions.

Moreover, as still another prior art, disclosed is a solid-state image pickup device (CCD image sensor) characterized by including first and second charge-transfer paths (CCD registers) provided respectively on sides of a light-receiving part (pixel array), and a third charge-transfer path which is connected to output end sides of the respective first and second charge-transfer paths and which has an independent output unit (amplifier), and characterized in that signals are read out individually from the first and second charge-transfer paths in high-speed readout, and signals from the first and second charge-transfer paths are read out alternately through the third charge-transfer path in low-speed readout (see Patent Document 4). It is said that, with this configuration, both high-speed operation and low-speed operation can be achieved.

[Patent Document 1] Japanese Patent Application Laid Open No. Hei 7-58317
[Patent Document 2] Japanese Patent Application Laid Open No. Hei 6-236982

### [Patent Document 3] Japanese Patent Application Publication No. 2007-124174

[Patent Document 4] Japanese Patent Application Laid Open No. Sho 58-190169

### SUMMARY

As described above, the CCD image sensor 101 shown in FIG. 4 (Patent Document 1) and the CCD image sensor 201 shown in FIG. 6 (Patent Document 2) take the same time period to transfer all the pixels, if having the same driving frequency f of the CCD registers 105, 106. However, there is a difference between the amplifier output stabilization periods A and B. Specifically, the stabilization period B of the CCD image sensor 201 including the two amplifiers 209, 210 is longer than the stabilization period A of the CCD image sensor 101 including the single amplifier 108. The stabilization periods A, B decrease, as the driving frequency f increases. The decrease of the stabilization periods A, B causes inconvenience in processing to be performed thereafter, such as sampling in A/D conversion.

It is said that the CCD image sensor 101 shown in FIG. 4 is suitable for power saving because only the single amplifier 108 is included in the configuration. However, the CCD image sensor 101 has the relatively short stabilization period A as described above, and therefore the allowable increase range of the driving frequency f is small. There is room for improvement in achieving speeding up.

By contrast, the CCD image sensor 201 shown in FIG. 6 has the relatively long stabilization period B as described above, and therefore the allowable increase range of the driving frequency f is wide. Hence, it is said that the CCD image sensor 201 is suitable for speeding up. However, since the CCD image sensor 201 uses the two amplifiers 209, 210, there is room for improvement in achieving power saving.

Meanwhile, the device according to the aforementioned Patent Document 3 includes, for one pixel array, the two, i.e., the first and second horizontal transmission means (CCD registers), and the three, i.e., the first to third output, means (amplifiers). Specifically, the first output means is provided on one end portion of the first horizontal transmission means, and the second and third output means are provided respectively on right and left end portions of the second horizontal transmission means. As described above, the device according to Patent Document 3 is provided with the three output means for one pixel array, and therefore has a problem of being difficult to achieve power saving. Furthermore, when signals are outputted from the multiple output means, generation of multiple timing signals is required. In order to generate these timing signals, generation of multiple different clock signals may be required (see paragraphs 0033 and 0034 in the document). In the generation of the clock signals, there is a problem such as increase of load on a circuit, for example, provision of a switching mechanism and generation of a new pattern.

Moreover, the device according to Patent Document 4 also requires the three output units (amplifiers) for one pixel array, and therefore has a problem of being difficult to achieve power saving. Furthermore, it is assumed, for this device, that the phases of the charge-transfer paths (CCD registers) are shifted for the low-speed operation (see the last paragraph in the left column continuing to the right column, on Page 3 of the document). In other words, each of the first and second charge-transfer paths uses two phases for high-speed and low-speed, and thus it is expected that four clock signals in total are required. Increase of the number of the clock signals causes problems such as increase of load on a circuit, as described above.

A charge coupled device (CCD) image sensor of an exemplary aspect according to the present invention, includes a first CCD register and a second CCD register which are arranged so as to sandwich a pixel array therebetween, each of which reads out and transfers a charge stored by the pixel array, and whose end portions in a transfer direction of the charge are connected to each other at a connection portion, the pixel array being formed of a plurality of light-receiving elements for performing photoelectric conversion, a first output portion provided to the connection portion of the first and second CCD registers, and which converts the charge transferred by each of the first and second CCD registers into a voltage and then outputs the voltage, a third CCD register which reads out and transfers the charge transferred by one of the first and second CCD registers, a second output portion provided to an end portion, in a transfer direction of the charge, of the third CCD register, and which converts a charge transferred by the third CCD register into a voltage and then outputs the voltage, and a switch which changes, depending on an operation mode, whether or not to perform an output by the second output portion.

According to the above configuration, outputting of a voltage signal as the detection result can be performed in two patterns. In the first pattern, charges stored by the pixel array are transferred by the first and second CCD registers, and outputted by the first output means. In the second pattern, charges stored by the pixel array are transferred by the first and third (or second and third) CCD registers, and outputted by the first and second output means. In other words, in the first pattern, only the single output means (amplifier) is used, thereby achieving power saving. By contrast, in the second pattern, the two output means are used, thereby achieving speeding up. These first and second patterns are switched therebetween, depending on the operation mode, i.e., power saving mode (normal mode), high-speed mode and the like.

The present invention can provide a CCD image sensor which achieves both power saving and speeding up.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a diagram showing a configuration of a CCD image sensor according to a first exemplary embodiment of the present invention;

FIG. 2 is a timing chart in the CCD image sensor according to the first exemplary embodiment;

FIG. 3 is a diagram showing a configuration of a CCD image sensor according to a second exemplary embodiment of the present invention;

FIG. 4 is a diagram showing a configuration of a CCD image sensor of a first related art;

FIG. 5 is a timing chart in the CCD image sensor shown in FIG. 4;

FIG. 6 is a diagram showing a configuration of a CCD image sensor of a second related art; and

FIG. 7 is a timing chart in the CCD image sensor shown in FIG. 6.

### DETAILED DESCRIPTION OF THE EXEMPLARY EMBODIMENTS

### First Exemplary Embodiment

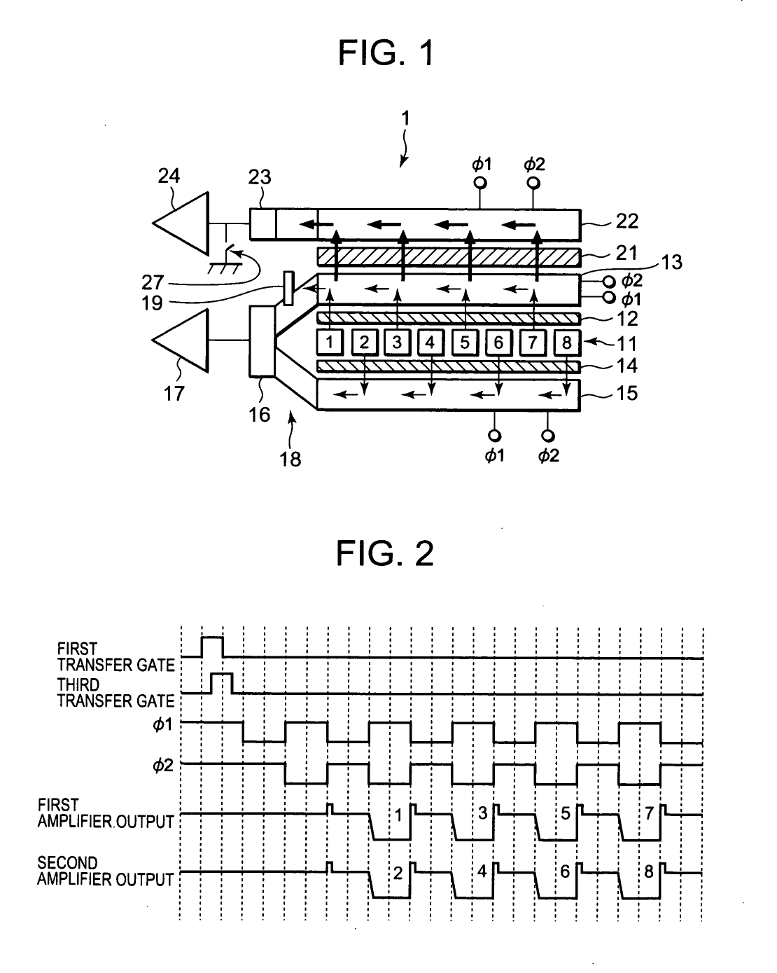

FIG. 1 is a diagram showing a configuration of a CCD image sensor 1 according to a first exemplary embodiment of the present invention. The CCD image sensor 1 includes a pixel array 11, a first transfer gate 12, a first CCD register 13, a second transfer gate 14, a second CCD register 15, a first signal charge detection unit 16, a first amplifier 17, a third transfer gate 21, a third CCD register 22, a second signal charge detection unit 23 and a second amplifier 24.

The pixel array 11 includes multiple cells including light receiving elements for generating charges each corresponding to incident light information. The number of pixels herein is assumed to be eight for simplicity of description. The first transfer gate 12 and the second transfer gate 14 are arranged so as to sandwich the pixel array 11 therebetween. The first CCD register 13 is arranged so as to sandwich the first transfer gate 12 between itself and the pixel array 11, while the second CCD register 15 is arranged so as to sandwich the second transfer gate 14 between itself and the pixel array 11.

When a gate pulse causing the first transfer gate 12 to be set to “H or activation” is applied, a charge of the pixel array 11 is read out to the first CCD register 13. When a gate pulse causing the second transfer gate 14 to be set to “H” is applied, a charge of the pixel array 11 is read out to the second CCD register 15. In the exemplary embodiment, a charge of an odd-numbered pixel is read out to the first CCD register 13, while a charge of an even-numbered pixel is read out to the second CCD register 15. The first and second CCD registers 13, 15 respectively transfer the read out charges in the same direction in synchronization with applied shift pulses φ1, φ2.

Connection parts 18 connected to each other are formed in one end portion, in the transfer direction, of the first and second CCD registers 13, 15, respectively. The first signal charge detection unit 16 is provided on the connection parts 18. The first signal charge detection unit 16 is formed of a floating diffusion area, and converts the charges transferred by the first and second CCD registers 13, 15 to voltages, respectively. The first amplifier 17 amplifies the voltage converted by the first signal charge detection unit 16 and then outputs the voltage to the outside. Meanwhile, a drain 19 is provided to an end portion, near the connection part 18, of the first CCD register 13, the drain 19 discharging a slight charge held by the first CCD register 13.

In the CCD image sensor 1 according to the exemplary embodiment, the third transfer gate 21 and the third CCD register 22 are sequentially arranged so as to be adjacent to the first CCD register 13. The third transfer gate 21 is disposed between the first CCD register 13 and the third CCD register 22. Moreover, the second signal charge detection unit 23 and the second amplifier 24 are disposed at one end portion, in a charge transfer direction, of the third CCD register 22. In the exemplary embodiment, the charge transfer direction of the third CCD register 22 is identical to those of the first and second CCD registers 13, 15.

When a gate pulse causing the third transfer gate 21 to be set to “H” is applied, a charge held by the first CCD register 13 is read out to the third CCD register 22. The third CCD register 22 transfers the charge read out from the first CCD register 13, in synchronization with applied shift pulses φ1 and φ2. The second signal charge detection unit 23 converts the charge transferred by the third CCD register 22, to a voltage. The second amplifier 24 amplifies the voltage converted by the second signal charge detection unit 23 and then outputs the voltage to the outside. Meanwhile, a switch 27 is provided between the second signal charge detection unit 23 and the second amplifier 24, the switch 27 allowing an input of the second amplifier 24 to be connected to GND.

With the above configuration, a voltage signal generated by photoelectric conversion can be outputted in two patterns. Specifically, in power-saving mode (normal mode), the third transfer gate 21 is fixed at “L or deactivation” so as to prevent the charge in the first CCD register 13 from leaking to the third CCD register 22, and to allow the charge in the first CCD register 13 to be outputted only from the first amplifier 17. Meanwhile, an input of the second amplifier 24 is connected to the GND by the switch 27 so as to prevent current consumption. Thus, when the high-speed operation is not required, only the single amplifier 17 is used to suppress power consumption.

By contrast, in high-speed mode, the third transfer gate 21 is set to “H” so as to cause the third CCD register 22 to read out the charge in the first CCD register 13. Furthermore, by using the switch 27, an input of the second amplifier 24 is disconnected from the GND. Accordingly, a charge of an odd-numbered pixel is outputted from the second amplifier 24 through the third CCD register 22, while a charge of an even-numbered pixel is outputted from the first amplifier 17 through the second CCD register 15. In this manner, when the high-speed operation is required, the two amplifiers 17, 24 are used to enable high-speed processing.

FIG. 2 shows a timing chart in the high-speed mode. In this case, firstly, in a period during which the first transfer gate 12 is set to “H,” the first CCD register 13 is set to “H,” so that the charge stored in the pixel array 11 is read out to the first CCD register 13. Next, while the first CCD register 13 is kept at “H,” the third transfer gate 21 is set to “H,” so that the charge is read out to the third transfer gate 21. Here, the third transfer gate 21 needs to have a deeper channel potential than the first CCD register 13, which is caused by certain processing such as increasing an applied voltage. Subsequently, the third transfer gate 21 is set to “L,” so that the charge is read out to the third CCD register 22. In order to prevent this charge from going back to the first CCD register 13, a potential gradient is provided to the third transfer gate 21 by certain processing such as ion implantation. The charge read out to the third CCD register 22 is transferred through here, and then outputted from the second amplifier 24 through the second signal charge detection unit 23. Additionally, the first CCD register 13 is continued to operate even after transferring the charge to the third transfer gate 21. At this timing, a slight charge existing in the first CCD register 13 is discharged by setting the drain 19 to “H.”

As described above, according to the exemplary embodiment, the number of the amplifiers 17, 24 to be used can be changed according to the operation mode, and thus both power saving and speeding up can be achieved. Furthermore, the CCD registers 12, 15, 22 according to the exemplary embodiment operate in the same manner regardless of whether low speed or high speed mode. This eliminates the need to generate the clock signals separately.

### Second Exemplary Embodiment

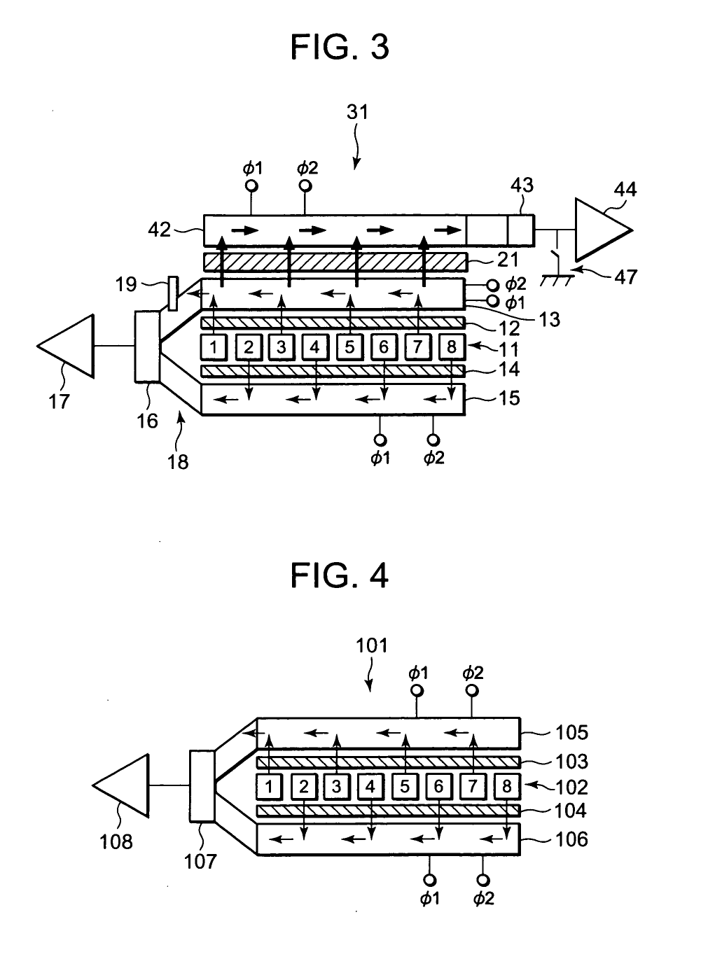

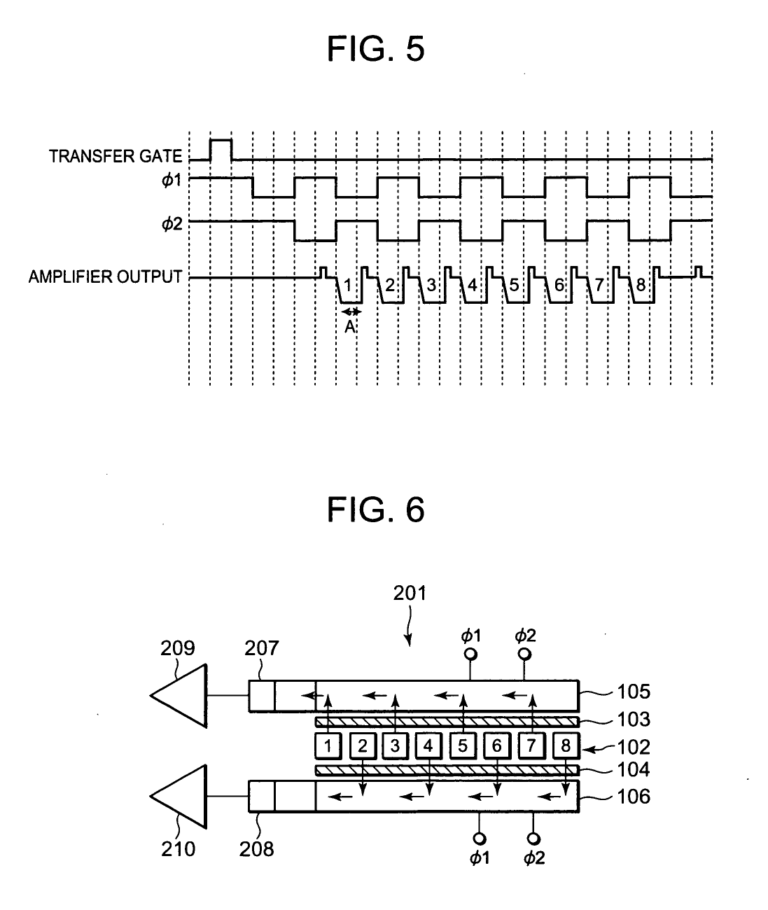

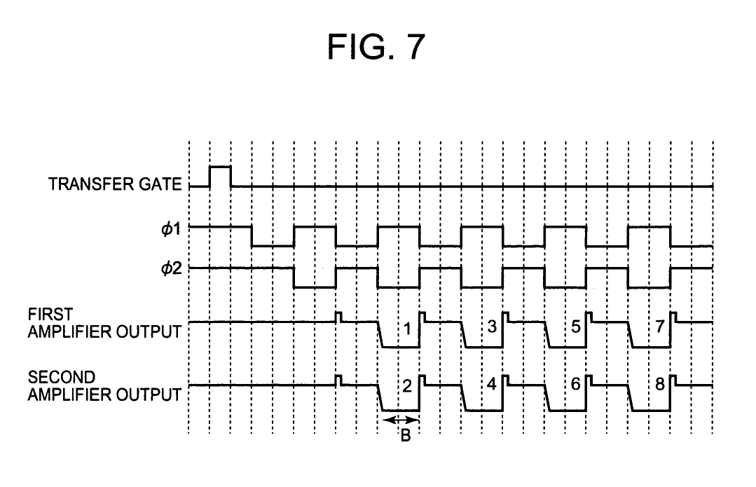

FIG. 3 is a diagram showing a configuration of the CCD image sensor 31 according to a second exemplary embodiment. A difference in this CCD image sensor 31 with respect to the CCD image sensor 1 according to the first exemplary embodiment is that the charge transfer direction of a third CCD register 42 is opposite to that of the first and second CCD registers 13, 15. Additionally, this causes a third signal charge detection unit 43, a third amplifier 44 and a switch 47 to be arranged on the opposite side as compared to the first exemplary embodiment. Note that, by disposing electrodes in advance so as to transfer the charge in the opposite direction, the third CCD register 42 can be operated by use of the same clock signal as those for the first and second CCD registers 13, 15.

As described above, arrangement of the two amplifiers 17, 44 at respective sides of the pixel array 11 can reduce generation of heat from a chip. For example, in a case of a one-dimensional image sensor for A3/600 dpi, 7100 or more pixels are required. On the assumption that the size of a pixel is 5 μm in this case, the size of the total pixels is 7100*5=35500 μm≈3.5 cm. Furthermore, assume that the length of each amplifier is 2000 μm. If the amplifiers are arranged on respective ends of the pixel array as in the second exemplary embodiment, then the amplifiers are sufficiently separated from each other. Accordingly, a sufficient effect of reduction in heat generation can be obtained.

Further, it is noted that Applicant's intent is to encompass equivalents of all claim elements, even if amended later during prosecution.

What is claimed is:

1. A charge coupled device (CCD) image sensor, comprising:
a first CCD register and a second CCD register which are arranged so as to sandwich a pixel array therebetween, each of the first and second CCD registers being reading out and transferring a charge stored by the pixel array, and including end portions in a transfer direction of the charge being connected to each other at a connection portion, the pixel array including a plurality of light-receiving elements for performing photoelectric conversion;
a first output portion provided to the connection portion of the first and second CCD registers, and which converts the charge transferred by each of the first and second CCD registers into a voltage, and then outputs the voltage;
a third CCD register which reads out and transfers the charge transferred by one of the first and second CCD registers;
a second output portion provided to an end portion, in a transfer direction of the charge, of the third CCD register, and which converts a charge transferred by the third CCD register into a voltage, and then outputs the voltage; and
a switch which changes, depending on an operation mode, whether or not to perform an output by the second output portion.

2. The CCD image sensor according to claim 1, wherein:
the transfer direction of the charge of the third CCD register is opposite to those of the first and second CCD registers; and
the first output portion and the second output portion are disposed at end portions of the pixel array, respectively.

3. The CCD image sensor according to claim 1, wherein the first to third CCD registers operate based on a same clock signal.

4. A CCD image sensor, comprising:
a light-sensitive element;
first and second output portions;
a first CCD register which receives a charge from the light-sensitive element, and transfers the charge to the first output portion;
a second CCD register which receives the charge from the light-sensitive element, and transfers the charge to the first output portion;
a first amplifier which amplifies the charge in the first output portion;
a third CCD register which receives the charge from the second CCD register, and transfers the charge to the second output portion; and
a second amplifier which amplifies the charge in the second output portion.

5. The CCD image sensor as claimed in claim 4, further comprising:
a switch which deactivates the second amplifier in a first mode, and activates the second amplifier in a second mode.

6. The CCD image sensor as claimed in claim 5,
wherein, in the first mode, the first amplifier outputs the charge alternately from the first and second CCD registers, based on a clock signal; and
wherein, in the second mode, the first amplifier only outputs the charge from the first CCD register, and the second amplifier outputs the charge from the second CCD register via the third CCD register, based on the clock signal.

7. The CCD image sensor as claimed in claim 4,
wherein the first output portion is arranged at a first side of the second CCD register, and the second output portion is arranged at a second side of the second CCD register opposite to the first side.
